(19) United States
(12) Patent Application Publication
(10) Pub. No.: US 2017/0282134 A1
(43) Pub. Date: Oct. 5, 2017

(54) APPARATUS FOR MAKING BATTERY SLURRY

(71) Applicants: Jiangsu Huadong Institute of Li-Ion Battery Co., Ltd., Suzhou (CN); Tsinghua University, Beijing (CN)

(72) Inventors: Xiang-Ming He, Beijing (CN); Hong-Sheng Zhang, Suzhou (CN); Jian-Jun Li, Beijing (CN); Li Wang, Beijing (CN); Yu-Ming Shang, Beijing (CN); Guan-Nan Qian, Suzhou (CN)

(73) Assignees: Jiangsu Huadong Institute of Li-Ion Battery Co., Ltd., Suzhou (CN); Tsinghua University, Beijing (CN)

(21) Appl. No.: 15/625,253

(22) Filed: Jun. 16, 2017

Related U.S. Application Data
(63) Continuation of application No. PCT/CN2015/095355, filed on Nov. 24, 2015.

(30) Foreign Application Priority Data
Dec. 16, 2014 (CN) 201410773503.2

(51) Int. Cl. B01F 3/12; B01F 13/10; B01F 7/16; B01F 15/00; B01F 7/30; B01F 7/00

(52) U.S. Cl. CPC B01F 3/1271; B01F 3/1221; B01F 3/1228; B01F 7/30; B01F 7/00116; B01F 7/00291; B01F 7/166; B01F 15/00831; B01F 13/1027; B01F 2003/1257; B01F 2003/125; B01F 2013/1052

(57) ABSTRACT

An apparatus for making a battery slurry is disclosed. The apparatus comprises a vacuum system providing a vacuum environment, a dry powder mixing device mixing a plurality of powdery materials uniformly to obtain a dry powder, a kneading device kneading the dry powder with the first part solvent to form a doughy mixture, and a high speed dispersing device dispersing the doughy mixture to the second part solvent to form the battery slurry. The vacuum system, the dry powder mixing device, the kneading device, and the high speed dispersing device are connected to each other.

### CROSS-REFERENCE TO RELATED APPLICATIONS

This application claims all benefits accruing under 35 U.S.C. §119 from China Patent Application No. 201410773503.2, filed on Dec. 16, 2014 in the State Intellectual Property Office of China, the content of which is hereby incorporated by reference. This application is a continuation under 35 U.S.C. §120 of international patent application PCT/CN2015/095355 filed on Nov. 24, 2015, the content of which is also hereby incorporated by reference.

### FIELD

The present disclosure relates to battery slurry manufacture technology, especially to an apparatus for making the battery slurry.

### BACKGROUND

In the manufacture of lithium ion batteries, the quality of the battery is strongly dependent on the quality of the battery slurry. The battery slurry is usually prepared by a planetary mixer. Raw materials such as an electrode active material, a conducting agent, a binder, an additive, and a solvent are added to the planetary mixer at one time in a predetermined proportion and mixed to obtain the battery slurry.

However, because different raw materials have vastly different densities (e.g. a density of spinel lithium-manganese oxide as the cathode active material is about 2.3 g/cm³, and a density of carbon black as the conducting agent is about 0.4 g/cm³), the raw materials may not be dispersed uniformly in the battery slurry. When stirring the raw materials, the raw materials with smaller densities are more likely to fly in the planetary mixer and stick to or get trapped in the planetary mixer, thereby causing a disproportionately larger among of the raw materials with larger densities. In addition, the powdery materials aggregate easily to form larger particles in the battery slurry. Therefore, to obtain the battery slurry with better uniformity, the raw materials must be stirred for a long time, sometime for as long as about 480 minutes to about 720 minutes.

### SUMMARY

An apparatus for making a battery slurry is provided. The battery slurry with uniformly dispersed uniform sized particles can be made effectively by the apparatus.

In one embodiment, an apparatus for making the battery slurry is configured to mix a plurality of powdery materials and a solvent in a predetermined proportion to form the battery slurry. The solvent comprises a first part solvent and a second part solvent. The apparatus comprises a vacuum system to provide a vacuum environment, a dry powder mixing device to mix the plurality of powdery materials uniformly to obtain a dry powder, a kneading device to knead the dry powder with the first part solvent to form a doughy mixture, and a high speed dispersing device to high-speed disperse the doughy mixture to the second part solvent to form the battery slurry. The vacuum system, the dry powder mixing device, the kneading device, and the high speed dispersing device are sequentially connected to each other.

In another embodiment, an apparatus for making the battery slurry is configured to mix a plurality of powdery materials and a solvent in a predetermined proportion to form the battery slurry. The solvent comprises a first part solvent and a second part solvent. The apparatus comprises a vacuum system, a dry powder mixing device, and a kneading device sequentially connected to each other. The vacuum system is configured to provide a vacuum environment for the dry powder mixing device and the kneading device. The dry powder mixing device is configured to mix the plurality of powdery materials uniformly to obtain a dry powder. The kneading device comprises a tank, at least two kneading blades disposed in the tank, and a high speed dispersing paddle disposed in the tank. The at least two kneading blades are configured to knead the dry powder with the first part solvent to form a doughy mixture. The high speed dispersing paddle is configured to high-speed disperse the doughy mixture to the second part solvent to form the battery slurry.

In the present disclosure, a uniform battery slurry with uniformly sized particles can be prepared by the apparatus. A doughy mixture can be obtained by mixing a dry powder and a first part solvent in the kneading device, squeezed, kneaded and rolled by the kneading device to wet the dry powder adequately in the first part solvent, thereby avoiding aggregation of the dry powder. Under an action of a high-speed stirring of the high speed dispersing device, the dry powder in the doughy mixture can be dispersed uniformly and quickly in a solvent composed by the first part solvent and the second part solvent to obtain the uniform battery slurry with small, uniformly dispersed particles.

### BRIEF DESCRIPTION OF THE DRAWINGS

Implementations are described by way of example only with reference to the attached figures.

FIG. 1 is a schematic view of one embodiment of an apparatus for making a battery slurry.

FIG. 2 is a schematic view of another embodiment of the apparatus for making the battery slurry.

FIG. 3 is a flow chart of one embodiment of a method for making the battery slurry.

### DETAILED DESCRIPTION

A detailed description with the above drawings is made to further illustrate the present disclosure.

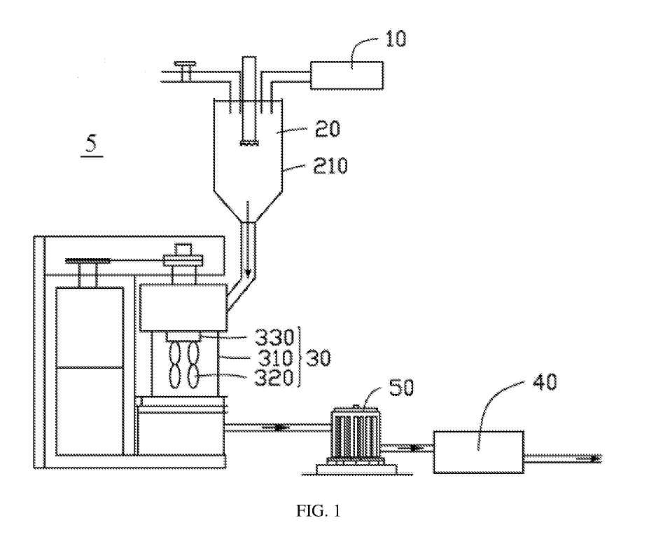

Referring to FIG. 1, one embodiment of an apparatus 5 for making a battery slurry comprises a vacuum system 10, a dry powder mixing device 20, a kneading device 30, and a high speed dispersing device 40 which are sequentially connected to each other.

The battery slurry can be made by mixing a dry powder having multiple components and a solvent, and dispersing the dry powder to the solvent. The battery slurry can be, but is not limited to, an electrode slurry of a lithium ion battery, an electrode slurry of a lead battery, or an electrode slurry of a nickel metal hydride battery. The dry powder can comprises a plurality of powdery materials to prepare the battery slurry. The solvent can comprise at least one liquid raw material to prepare the battery slurry.

In one embodiment, the battery slurry can be the electrode slurry of the lithium ion battery. The dry powder can comprise an active material, a conducting agent, and a binder. The active material can be an anode active material or a cathode active material. The conducting agent can be at least one of acetylene black, carbon black, graphite, carbon nanotubes, and graphene. The binder can be at least one of polyvinylidene fluoride, polytetrafluoroethylene, styrene butadiene rubber, and hydroxymethyl cellulose. The solvent can be at least one of N-methyl-2-pyrrolidone (NMP), N,N-dimethyl formamide (DMF), N,N-diethyl formamide (DEF), dimethyl sulfoxide (DMSO), tetrahydrofuran (THF), acetone, ethanol, and deionized water.

The apparatus 5 can disperse the dry powder to the solvent in a predetermined proportion and mix the dry powder with the solvent to obtain the battery slurry.

The vacuum system 10 provides a vacuum environment for the dry powder mixing device 20 and the kneading device 30. The vacuum system 10 can comprise a vacuum to generate a vacuum. The vacuum can be a pump to reduce the pressure in the dry powder mixing device 20. In the vacuum environment, air and water adsorbed on a surface of each solid raw material can be removed to prevent dust formation and to mix the plurality of powdery materials uniformly and quickly.

The dry powder mixing device 20 mixes the plurality of powdery materials uniformly without adding any solvent to obtain the dry powder. The type of the dry powder mixing device 20 is not limited. In one example, the dry powder mixing device 20 can comprise a container or a barrel 210 in which the plurality of powdery materials are mixed. The barrel 210 may or may not be rotated during the mixing. The dry powder mixing device 20 can provide a non-metal environment in which the plurality of powdery materials cannot contact any metal material to preventing the metal material entering and mixing with the battery slurry. A first inner wall of the barrel 210 can be made of a non-metal material. In one embodiment, the barrel 210 is made of the non-metal material. In another embodiment, the barrel 210 can be made of a metal material, and the non-metal material can be covered or coated on at least a portion of the metal material to form a first inner wall. A hardness of the non-metal material can be larger than a hardness of the metal material. The non-metal material can be at least one of fluorine plastic, tungsten carbide, silicon fluoride, and carbon material. The dry powder mixing device 20 can comprise a stirring paddle or not. In one embodiment, the plurality of powdery materials can be stirred and mixed by the stirring paddle. In another embodiment, the plurality of powdery materials can be mixed only by a rotation of the barrel 10. The stirring paddle can be made of a non-metal material or a metal material at least partially covered with a non-metal material.

The solvent can be divided into a first part solvent and a second part solvent. The first part solvent and the second part solvent can be respectively added to the apparatus 5 at different times. In the battery slurry, the dry powder can be dispersed by the solvent composed of the first part solvent and the second part solvent.

The kneading device 30 kneads the dry powder and the first part solvent to form a uniform and stable doughy mixture. The doughy mixture can be plastic and can be kneaded and coiled like a dough. The kneading device 30 can comprise a tank 310 and a blender. The blender can be at least two kneading blades 320.

The uniform dry powder and the first part solvent can be kneaded in the tank 310. A structure of the tank 310 is not limited. The tank 310 can comprise a bottom wall and a peripheral wall at an edge of the bottom wall. In one embodiment, the bottom wall can be circular, and the peripheral wall can be cylindrical, which is conducive to knead the dry powder and the first part solvent uniformly. The kneading device 30 can comprise a second inner wall to contact the dry powder and the first part solvent.

The at least two kneading blades 320 can be disposed in the tank 310. The at least two kneading blades 320 is rotatable in the tank 310 to knead the dry powder and the first part solvent, during which the dry powder adsorb the first part solvent and bond together to first form a preform mixture. The preform mixture is a semi-finished product of the doughy mixture and is non-uniform. The preform mixture can be plastic and can be kneaded and coiled. The preform mixture can be rotated by the at least two kneading blades 320 in the tank 310, during which when the preform mixture is moved between one kneading blade 320 and the second inner wall of the tank 310, the preform mixture is squeezed, kneaded, and rolled by the one kneading blade 320 and the second inner wall together. When the preform mixture is moved between any two kneading blades 320, the preform mixture is squeezed, kneaded, and rolled by the two kneading blades 320 together. During this process the dry powder is wetted by the first part solvent adequately, and the dry powder and the first part solvent are recombined and redistributed repeatedly, thereby avoiding the aggregation of the dry powder, and forming an uniform and stable doughy mixture. In addition, because the preform mixture is sticky, it can pull the residue dry power adsorbed on the second inner wall of the tank 310. After obtaining the uniform and stable doughy mixture, there is no dry powder adsorbed on the second inner wall, thereby maintaining the predetermined proportion of the dry powder and the solvent in the battery slurry and avoiding material waste.

The at least two kneading blades 320 can be spaced from each other so that rotations of the at least two kneading blades 320 are not affected by each other. In one embodiment, the at least two kneading blades 320 are parallel to and spaced from each other. The kneading device 30 can further comprise a driving unit 330 to rotate the at least two kneading blades 320.

In one embodiment, a shortest distance between the second inner wall of the tank 310 and a surface of each kneading blade 320 can be in a range from about 3 mm to about 5 mm, thereby applying a great pressure on the preform mixture when the preform mixture is moved between the second inner wall of the tank 310 and each kneading blade 320 to form the uniform doughy mixture quickly. In one embodiment, each kneading blade 320 can embody a FIG. 8 shaped structure. The FIG. 8 shaped structure can be a stereo-structure composed of two S-shaped structures connected end to end with each other. The kneading blade 320 with the FIG. 8 shaped structure can apply a large, continuous pressure on the preform mixture, thereby forming the uniform doughy mixture more quickly. In one embodiment, the at least two kneading blades 320 are rotatable like a planet in orbit during kneading. That is, each kneading blade 320 rotates around its own axis (first axis) and simultaneously revolves around a second axis different from the first axis, so that the preform mixture can be continuously rotated and repeatedly pressed in the tank 310 to uniformly mix the dry powder and the first part solvent. The at least two kneading blades 320 can revolve around the same second axis. The second axis can be a central axis of the tank 310. The at least two kneading blades 320 can rotate around the first axis at a same first speed in a same first direction, and revolve around the second axis at a same second speed in a same second direction, so that the at least two kneading blades 320 do not influence each other during the rotation.

The apparatus 5 can further comprise a conveying device 50. The conveying device 50 can move the doughy mixture from the kneading device 30 into the high speed dispersing device 40 by, for example, pushing the doughy mixture. The conveying device can be located between the kneading device 30 and the high speed dispersing device 40. The type of conveying device 50 is not limited. In one embodiment, the conveying device 50 is a screw conveyor.

A type of the high speed dispersing device 40 is not limited. In one embodiment, a linear velocity of a material dispersed in the high speed dispersing device 40 can be larger than 15 m/s. After the doughy mixture is pushed into the high speed dispersing device 40, the second part solvent can be added to the high speed dispersing device 40. The doughy mixture and the second part solvent can be mixed and dispersed quickly at a high speed in the high speed dispersing device 40, thereby dispersing the dry powder to the solvent composed of the first part solvent and the second part solvent uniformly and quickly. Because the dry powder is uniformly dispersed into the first part solvent in the doughy mixture, the dry powder cannot be aggregated when dispersing the doughy mixture into the second part solvent, thereby obtaining the uniform battery slurry containing small particles quickly.

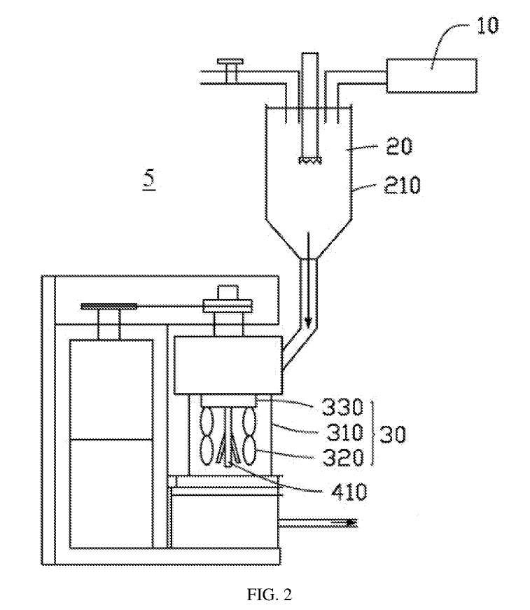

The kneading device 30 and the high speed dispersing device 40 can be integrated as one device. Referring to FIG. 2, in one embodiment, a high speed dispersing paddle 410 can be disposed in the tank 310 of the kneading device 30. The high speed dispersing paddle 410 can have the same function as the high speed dispersing device 40, so that the kneading device 30 can have both a kneading function and a high speed dispersing function. When performing the kneading function, only the at least two kneading blades 320 are driven. When performing the high speed dispersing function, only the high speed dispersing paddle 410 is driven, or both the at least two kneading blades 320 and the high speed dispersing paddle 410 can be driven to disperse the doughy mixture to the second part solvent more quickly.

The at least two kneading blades 320 and the high speed dispersing paddle 410 can be parallel to and spaced from each other. In one embodiment, the high speed dispersing paddle 410 is rotatable like a planet in orbit. That is, the high speed dispersing paddle 410 rotates around its own axis (third axis) and revolves around a fourth axis different from the third axis. The fourth axis can also be the central axis of the tank 310. In one embodiment, the high speed dispersing paddle 410 is capable of rotating around the third axis at the first speed in the first direction, and revolving around the fourth axis at the second speed and in the second direction, so that the at least two kneading blades 320 and the high speed dispersing paddle 410 are not affected by each other during the rotation.

The at least two kneading blades 320 and the high speed dispersing paddle 410 can be made of a non-metal material, or made of a metal material at least partially covered with a non-metal material. The second inner wall of the tank 310 can be made of the non-metal material, or made of the metal material at least partially covered with a non-metal material. In one embodiment, all walls of the apparatus 5 capable of directly contacting the dry powder and the solvent can be made of the non-metal material, or made of the metal material at least partially covered with a non-metal material.

The apparatus 5 can further comprise a heating system (not shown) to heat the dry powder mixing device 20, the kneading device 30, and the high speed dispersing speed 40, respectively.

In the present disclosure, the uniform battery slurry with small particles can be prepared by the apparatus 1 quickly and effectively. The plurality of powdery materials can be uniformly mixed in the dry powder mixing device 20 to obtain the dry powder. The doughy mixture can be obtained by mixing the dry powder and the first part solvent in the kneading device 30, and squeezed, kneaded and rolled by the kneading device 30 to wet the dry powder adequately in the first part solvent, thereby avoiding aggregation of the dry powder. The dry powder can be dispersed uniformly and quickly in the solvent by mixing the doughy mixture and the second part solvent at high speed in the high speed dispersing device 40 to obtain the uniform battery slurry with the corrected predetermined proportion.

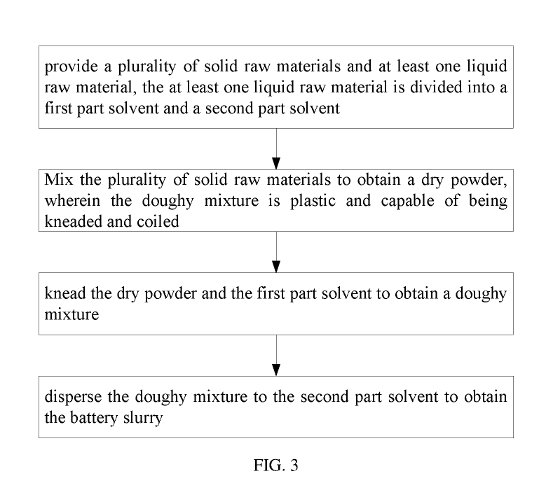

Referring to FIG. 3, one embodiment of a method for making a battery slurry comprises the following steps:

S1, providing the plurality of powdery materials and the solvent in a predetermined proportion, with the solvent divided into a first part solvent and a second part solvent;

S2, mixing the plurality of powdery materials to obtain the dry powder;

S3, kneading the dry powder and the first part solvent to obtain the doughy mixture, wherein the doughy mixture is plastic and capable of being kneaded and coiled; and

S4, dispersing the doughy mixture to the second part solvent to obtain the battery slurry.

In the S1, the first part solvent and the second part solvent can be the same or different. In one embodiment, the first part solvent and the second part solvent can comprise different kinds of solvents. In another embodiment, a plurality of different kinds of solvents are mixed to form a solvent mixture, and the solvent mixture is divided into the first part solvent and the second part solvent.

In the S2, by first mixing the plurality of powdery materials uniformly, the doughy mixture can be obtained more quickly and uniformly in the kneading process. The plurality of powdery materials can be mixed in a vacuum environment, thereby removing the air and water adsorbed on a surface of each solid raw material to avoid dust formation and mix the plurality of powdery materials more quickly and uniformly. In one embodiment, the plurality of powdery materials can be heated during mixing to remove the air and water more quickly and mix the plurality of powdery materials uniformly more quickly. The plurality of powdery materials can be heated at a temperature range from about 30° C. to about 150° C. to prevent the plurality of powdery materials from melting or decomposing.

A mixing time of the plurality of powdery materials is not limited as long as the plurality of powdery materials can be mixed uniformly. In one embodiment, the mixing time can be in a range from about 30 minutes to about 120 minutes, which is enough time to mix the plurality of powdery materials uniformly.

In the S3, during the kneading, the dry powder adsorbs the first part solvent and bonds together to first form a preform mixture. The preform mixture is a semi-finished product of the doughy mixture and is non-uniform. The preform mixture can be plastic and can be kneaded and coiled. Because the preform mixture is squeezed, kneaded, and rolled continuously during the kneading, the dry powder is wetted by the first part solvent adequately to avoid the aggregation of the dry powder, and the dry powder and the first part solvent are re-combined and re-distributed repeatedly to form the uniform and stable doughy mixture. In addition, because the preform mixture is sticky to the residue dry power adsorbed on the second inner wall of the tank 310, after obtaining the uniform and stable doughy mixture, there is no dry powder remaining adsorbed on the second inner, thereby maintaining the predetermined proportion of the dry powder and the solvent in the battery slurry and avoiding material waste.

An amount of the first part solvent can be controlled to obtain the doughy mixture according to properties of the plurality of powdery materials and the solvent. In one embodiment, a mass ratio between the dry powder and the first part solvent can be in a range from about 1:9 to about 1:1, which is conducive to obtain the uniform and stable doughy mixture more quickly, and shortens a preparation time of the battery slurry.

The dry powder and the first part solvent can be kneaded in a vacuum environment to prevent the air mixing with the dry powder and the first part solvent to shorten a kneading time. In one embodiment, a vacuum pressure of the vacuum environment can be lower than −0.09 MPa. The dry powder and the first part solvent can be kneaded at a temperature ranged from about 25° C. to about 45° C., which is conducive to dissolve the binder in the first part solvent to obtain the preform mixture more quickly with a proper viscosity, and knead the preform mixture more quickly to obtain the doughy mixture.

In one embodiment, a kneading time can be in a range from about 30 minutes to about 120 minutes to obtain the uniform and stable doughy mixture.

In the S4, a method for dispersing the doughy mixture to the second part solvent is not limited. In one embodiment, the doughy mixture can be dispersed to the second part solvent by stirring. Because the dry powder is dispersed in the first part solvent uniformly in the doughy mixture, the dry powder cannot be aggregated together and can be dispersed in the solvent composed by the first part solvent and the second part solvent uniformly and quickly to form the battery slurry with small particles. In one embodiment, a component of the part first solvent can be same as a component of the second solvent, so that the doughy mixture can be diluted by the second solvent to obtain the battery slurry more quickly.

The doughy mixture can be dispersed to the second part solvent at a linear speed larger than or equal to 15 m/s. In one embodiment, the linear speed can be in a range from about 15 m/s to about 70 m/s, so that not only the doughy mixture can be dispersed to the second part solvent more quickly, but morphologies of solid particles comprised in the battery slurry cannot be destroyed. The doughy mixture can be dispersed to the second part solvent at a temperature from about 25° C. to about 45° C., which is conductive to disperse the doughy mixture to the second liquid solvent more quickly due to a proper viscosity of the doughy mixture.

In one embodiment, a dispersing time for dispersing the doughy mixture to the second part solvent can be in a range from about 5 minutes to about 30 minutes.

In the present disclosure, the dry powder and the first part solvent are first kneaded to obtain the doughy mixture. Thereafter, the doughy mixture is dispersed to the second part solvent to obtain the battery slurry. In the process of kneading, the dry powder is wetted by the first part solvent adequately and dispersed to the first part solvent quickly without aggregation, thereby dispersing the dry powder to the solvent composed by the first part liquid and the second part liquid when dispersing the doughy mixture to the second part liquid to obtain the battery slurry with small particles quickly. A total preparation time of the battery slurry can be in a range from about 65 minutes to about 270 minutes. A high quality battery slurry can be obtained quickly and effectively without any residue by the present method. The high quality battery slurry can be used to prepare a battery directly without filtration due to the small particles.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An apparatus for making a battery slurry, the apparatus operated to mix a plurality of powdery materials and at least one liquid raw material to form the battery slurry, wherein the at least one liquid raw material comprises a first part solvent and a second part solvent, the apparatus comprising:
a dry powder mixing device to mix the plurality of powdery materials uniformly to obtain a dry powder, the dry powder mixing device comprising a container to hold the plurality of powdery materials;
a kneading device to knead the dry powder with the first part solvent to form a doughy mixture, the kneading device comprising a tank and a movable blender;
a vacuum system comprising a vacuum to reduce the pressure inside the dry powder mixing device and the kneading device; and
a high speed dispersing device to disperse the doughy mixture to the second part solvent to form the battery slurry, the high speed dispersing device comprising a high speed dispersing paddle.

2. The apparatus of claim 1, wherein the blender comprises at least two kneading blades disposed in the tank.

3. The apparatus of claim 2, wherein a shortest distance between an inner wall of the tank and a surface of each kneading blade is in a range from about 3 mm to about 5 mm.

4. The apparatus of claim 2, wherein each kneading blade has a FIG. 8 shaped structure, the FIG. 8 shaped is a stereo-structure comprising two S-shaped structures connected end to end with each other.

5. The apparatus of claim 2, wherein the at least two kneading blades are parallel to and spaced from each other.

6. The apparatus of claim 2, wherein each kneading blade is configured to rotate around a first axis and configured to revolve around a second axis different from the first axis.

7. The apparatus of claim 6, wherein the second axis is a central axis of the tank.

8. The apparatus of claim 6, wherein the at least two kneading blades are configured to rotate at a first speed in a first direction, and the at least two kneading blades are configured to revolve at a second speed in a second direction.

9. The apparatus of claim 1, wherein walls of the apparatus contacting the dry powder or the solvent is made of a non-metal material, or made of a metal material covered at least partially with the non-metal material.

10. The apparatus of claim 9, wherein a hardness of the non-metal material is larger than a hardness of the metal material.

11. The apparatus of claim 9, wherein the non-metal material can be selected from the group consisting of fluorine plastic, tungsten carbide, silicon fluoride, carbon material, and combinations thereof.

12. The apparatus of claim 1, further comprising a conveying device, the conveying device configured to transport the doughy mixture from the kneading device into the high speed dispersing device.

13. The apparatus of claim 12, wherein the conveying device is connected between the kneading device and the high speed dispersing device.

14. An apparatus for making a battery slurry, the apparatus operated to mix a plurality of powdery materials and at least one liquid raw material to form the battery slurry, wherein the at least one liquid raw material comprises a first part solvent and a second part solvent, the apparatus comprising:
a dry powder mixing device to mix the plurality of powdery materials uniformly to obtain a dry powder; and
a kneading device, the kneading device comprising a tank, at least two kneading blades disposed in the tank, and a high speed dispersing paddle disposed in the tank, wherein the at least two kneading blades are configured to knead the dry powder with the first part solvent to form a doughy mixture, and the high speed dispersing paddle is configured to disperse the doughy mixture to the second part solvent to form the battery slurry.

15. The apparatus of claim 14, wherein the least two kneading blades and the high speed dispersing paddle are parallel to and spaced from each other.

16. The apparatus of claim 14, wherein each kneading blade is configured to rotate around a first axis and revolve around a second axis different from the first axis, and the high speed dispersing paddle is configured to rotate around a third axis and revolve around a fourth axis different from the third axis.

17. The apparatus of claim 16, wherein the second axis and the fourth axis are both a central axis of the tank.

18. The apparatus of claim 14, wherein a shortest distance between an inner wall of the tank and a surface of each kneading blade is in a range from about 3 mm to about 5 mm.

19. The apparatus of claim 14, wherein each kneading blade is a FIG. 8 shaped structure, the FIG. 8 shaped structure is a stereo-structure comprising two S-shaped structures connected end to end with each other.

20. The apparatus of claim 14, wherein walls of the apparatus contacting the dry powder or the solvent is made of a non-metal material, or made of a metal material covered at least in part by the non-metal material.
